(19) United States
(12) Patent Application Publication
(10) Pub. No.: US 2022/0137628 A1
(43) Pub. Date: May 5, 2022

(54) LOCALIZATION SYSTEM FOR A DRIVERLESS VEHICLE

(71) Applicant: ZF Friedrichshafen AG, Friedrichshafen (DE)

(72) Inventors: Steffen Biel, Friedrichshafen (DE); Eduardo Neiva, Friedrichshafen (DE); Daniel Wolf, Friedrichshafen (DE); Bastian Volpert, Friedrichshafen-Kluftern (DE)

(21) Appl. No.: 17/436,666

(22) PCT Filed: Mar. 4, 2020
(86) PCT No.: PCT/EP2020/055642

§ 371 Date: Sep. 7, 2021

(30) Foreign Application Priority Data
Mar. 8, 2019 (DE) 10 2019 203 202.8

(51) Int. Cl. G05D 1/02; G01S 5/02; G01S 19/49

(52) U.S. Cl. CPC G05D 1/0212; G05D 1/0287; G05D 1/0257; G05D 1/0255; G01S 19/49; G05D 1/0278; G05D 1/0268; G01S 5/0264; G05D 1/0231

(57) ABSTRACT

A localization system for a driverless vehicle configured to drive in a driverless manner from a starting point to a destination point includes a set of sensors configured to localize the vehicle indoors and at least one capture device configured to localize the vehicle outdoors. The localization system is configured to provide at least one orientation point at a transition area between outdoors and indoors or vice versa. The localization is also configured to switch from a localization method for localizing the vehicle indoors to a localization method for localizing the vehicle outdoors or vice versa in response to capturing, by the set of sensors and/or the capture device, the at least one orientation point.

### CROSS REFERENCE TO RELATED APPLICATIONS

This application is a U.S. National Phase application under 35 U.S.C. § 371 of International Application No. PCT/EP2020/055642, filed on Mar. 4, 2020, and claims benefit to German Patent Application No. DE 10 2019 203 202.8, filed on Mar. 8, 2019. The International Application was published in German on Sep. 17, 2020 as WO 2020/182560 A1 under PCT Article 21(2).

### FIELD

The present disclosure relates to a localization system for a driverless vehicle and to a method for localizing the driverless vehicle.

### BACKGROUND

Driverless vehicles need a surrounding area that is as static as possible in order to be able to locate themselves safely and then navigate accordingly. Localization takes place indoors with the assistance of environmental sensors and outdoors with the assistance of GNSS.

In particular indoors, i.e., for example, in a hall, localization takes place on the basis of orientation in relation to the infrastructure, for example by means of sensors and SLAM methods for creating a local map of the surrounding area. Outdoors, localization takes place by means of GNSS, i.e., in a manner supported by satellites, since there is usually no static infrastructure, or no sufficient static infrastructure, in relation to which the vehicle can be oriented. The transition between outdoors and indoors or between indoors and outdoors, i.e., the reliable switching between two localization methods, is problematic.

### SUMMARY

In an embodiment, the present disclosure provides a localization system for a driverless vehicle configured to drive in a driverless manner from a starting point to a destination point. The localization system includes a set of sensors configured to localize the vehicle indoors and at least one capture device configured to localize the vehicle outdoors. The localization system is configured to provide at least one orientation point at a transition area between outdoors and indoors or vice versa. The localization is also configured to switch from a localization method for localizing the vehicle indoors to a localization method for localizing the vehicle outdoors or vice versa in response to capturing, by the set of sensors and/or the capture device, the at least one orientation point.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a localization system for controlling a driverless vehicle from a starting point to a destination point according to one embodiment.

### DETAILED DESCRIPTION

The present disclosure provides a localization system for a driverless vehicle that can execute reliable switching between a localization method outdoors and a localization method indoors or vice versa. The system thus enables reliable localization of a driverless vehicle in a transition area between indoors and outdoors or vice versa.

For applications indoors, driverless vehicles, i.e., automated up to autonomous vehicles, use laser scanners for localizing and navigating the vehicle as well as for capturing the environment. Thus, a suitable travel path from a starting point to a destination point, which can be driven without any collisions, is determined. The set of sensors used for indoors is generally only suitable for indoor use, e.g., in halls, due to its sensitivity to dirt and weather conditions.

For outdoor applications, a satellite-supported GNSS is advantageously used for localization in driverless vehicles, i.e., in automated up to autonomous vehicles. However, this cannot be used indoors since signal reception is generally too weak or unreliable.

The systems used indoors and outdoors function independently of one another very well for localizing the vehicle in the respective area. It is difficult to reliably recognize the transition between the areas, i.e., between indoors and outdoors or vice versa, and to switch the localization method correspondingly quickly. This is achieved by the system described below.

Proposed is a localization system for a driverless vehicle, which moves in a driverless manner from a starting point to a destination point, wherein the localization system has a set of sensors for localizing the vehicle indoors and additionally at least one capture device for localizing the vehicle outdoors. Furthermore, the localization system provides at least one orientation point at a transition area between outdoors and indoors or vice versa, wherein a switching takes place from a localization method for localizing the vehicle indoors to a localization method for localizing the vehicle outdoors or vice versa when the at least one orientation point is captured by the set of sensors and/or the capture device.

A driverless vehicle drives in a manner automated up to autonomous (corresponds to level 2 SAE J3016 autonomy level and higher). Control is made possible by one or more control devices that process the data necessary for providing a corresponding collision-free trajectory and output corresponding control signals to the actuators of the vehicle in order to implement the driving task. The required data are determined by sets of sensors and/or capture devices that are installed on the vehicle and receive information regarding the surrounding area of the vehicle, for example regarding its location. Depending on the position or location of the vehicle, the vehicle is located by means of corresponding localization methods. Based on this Information, navigation from a starting point to a destination point can then take place.

If the driverless vehicle moves from indoors to outdoors or vice versa, it may be that the localization devices used for the respective area, i.e., the sets of sensors or capture devices, no longer provide reliable localization since they no longer receive a stable signal, for example, or there is no infrastructure for orientation. A change in the localization method is thus necessary. The transition between such areas, also referred to as a transition area, must be recognized reliably in order to enable seamless driving between the areas. However, neither the set of sensors for localizing indoors nor the capture device for localizing outdoors can perform this task satisfactorily. For this reason, at least one orientation point, also called a landmark, is provided at the transition area and identifies the corresponding area as the transition area.

The goal of localization is to determine the exact position of the vehicle and to be able to provide it at any time. In doing so, the vehicle position always comprises the location of the vehicle in a coordinate system X, Y, Z (global or local) along with the orientation of the vehicle as an orientation or Euler angle (roll, pitch, yaw). For accurate orientation and localization, maps are provided, which are either stored beforehand or are determined in real time, e.g., by means of SLAM.

By providing at least one orientation point, the transition of the localization of the vehicle by means of GNSS to the localization by the set of sensors and/or vice versa can take place. There are only very limited orientation points outdoors, which is why navigation generally takes place in a manner supported by satellites. The position of the vehicle can be recorded in the global map and the local map by means of the orientation point(s) so that the transition in both maps is marked and such information can be used to control the driverless vehicle. Switching can thus already be prepared upon detection of the approaching of or (shortly before) entering a transition area and then carried out when passing through the transition area.

In one embodiment, the at least one orientation point is one of a QR code, a defined structure of an infrastructure, one or more permanently installed objects, one or more tracks, or a combination thereof.

A QR code can be attached to the transition area and can be captured by the set of sensors arranged on the vehicle. Advantageously, capture takes place as optical recording, i.e., for example, by means of a camera. A defined infrastructure can be captured via different sensor systems of the set of sensors. An orientation point that identifies the infrastructure can be a roof of a hall or its presence or absence, a gate or entrance/exit gate serving as a transition area, a frame of an opening into indoors or to outdoors, a building edge, or even a prominent building feature. Permanently installed objects can likewise serve as orientation points. Such permanently installed objects are, for example, one or more posts, a gate, signs fastened to a building or to the transition area, or other permanently installed objects. One of its tracks may also serve as an orientation point. Either its presence or absence can indicate a transition between indoors and outdoors. However, a change in the type or color of the lines can also indicate such a transition. A transition area can also be indicated by a change in the line design, e.g., by a transverse line.

In one embodiment, the orientation point is captured by optical recording or by 3D recording. The type of capture, and thus of the set of sensors, is to be selected depending on the type of orientation point. 3D recording, e.g., by means of 3D radar or 3D lidar in conjunction with SLAM, can be useful for capturing a frame or gate. In the detection of whether a hall roof is present, i.e., the vehicle is located indoors, or only the sky, i.e., the vehicle is located outdoors, optical recording by means of a camera can be useful.

In one embodiment, localization outdoors takes place by means of the capture device via GNSS, i.e., in a manner supported by satellites. In addition, localization can also take place by means of an inertial sensor system, so-called IMUs. Such sensors are a spatial combination of a plurality of inertial sensors, which in particular have acceleration sensors and rotational rate sensors and capture the object's own movement. Localization via GNSS can be supported by using IMUs.

In one embodiment, the set of sensors for localizing indoors comprises at least one of LIDAR, RADAR, camera, ultrasound, WLAN, UWB, radio, camera or a combination thereof. Localization can take place by means of SLAM since a current map of the surrounding area is always provided in this case. Such localization by means of the systems just mentioned can of course be used outdoors as well.

The term “SLAM,” which results from Simultaneous Localization and Mapping and is called Simultane Positionsbestimmung and Kartenerstellung in German, is to be understood as a method with which a mobile vehicle simultaneously creates a map of its surrounding area and estimates its position (pose) within this map. With SLAM localization, for example, the method of “scan matching” attempts to find a match of the currently measured point cloud within a previously stored map.

For example, the vehicle is a driverless transport vehicle. In the logistics sector, transport vehicles are used to transport goods, load them into designated storage facilities and unload them from such facilities. Newer developments make it possible to carry out much of this work in a driverless manner, i.e., automatically or even autonomously. In order to enable driverless driving, corresponding sensor systems or sets of sensors on the vehicle are required. Corresponding control units are also required, which process the sensor data and then specify the travel path to be driven to the vehicle.

A driverless transport vehicle (fahrerloses Transportfahrzeug), or FTF for short, or Automated Guided Vehicle, or AGV for short, is a floor-level conveyor or floor conveyor for short, which is used for horizontal and/or vertical material transport. Its drive is controlled by a control unit via corresponding control signals so that it can move in an automated or autonomous manner. Material transport is to be understood as driving of material from a place of departure to a place of destination but also loading and/or unloading material, e.g., from a high rack. In this case, the subsequent transport can be taken over by the same FTF or another vehicle.

By means of the proposed localization system, such a driverless transport vehicle can also transport material in a driverless manner from indoors to outdoors or vice versa.

Outdoors may be a factory site or a closed logistics terrain. Particularly in logistics traffic within closed terrains with and without halls, driverless vehicles or transport vehicles are used both indoors and outdoors so that the recognition of the transition area is necessary for seamless material transport and collision-free movement. A closed terrain is to be understood as a terrain in which only a defined traffic, i.e., only authorized vehicles, is permitted to drive. Moreover, the regulation of traffic in such terrains is provided specifically for such terrain.

In one embodiment, the localization system additionally has a communication device for communication with a guidance system additionally (optionally) provided at the transition area, wherein the guidance system is formed for the communication and control of a plurality of driverless vehicles.

With the assistance of the communication device, which allows so-called Car2X or V2X communication, a virtual traffic light could, for example, be installed at a building entrance, i.e., a transition area. Via a guidance system, this traffic light could authorize vehicles for entrance or exit or specify and/or control the further behavior of the vehicles. The navigation of various vehicles can thus additionally be coordinated via a guidance system. The communication system may be arranged in the driverless vehicle.

Furthermore, a method for localizing a driverless vehicle by means of the localization system is proposed. The localization system has already been described in the previous description. The localization system has a set of sensors for localizing the vehicle indoors and additionally at least one capture device for localizing the vehicle outdoors, wherein switching takes place between a localization method outdoors and a localization method indoors or vice versa of the driverless vehicle when the vehicle is detected as approaching or entering a transition area between outdoors and indoors or vice versa.

Advantageously, a plurality of driverless vehicles is controlled via a guidance system arranged in the transition area in such a way that coordination of the navigation of the plurality of vehicles takes place. A traffic flow, i.e., for example, an entrance and/or exit of a plurality of driverless vehicles into or out of indoors, can thus be controlled.

The FIGURE shows an exemplary scenario in which a travel path P of a driverless vehicle 1 is shown from a starting point or starting location S to a destination point or place of destination Z. The starting location S is located in an outdoor area “Outdoor.” The driverless vehicle 1 must first pass through an outdoor area “Outdoor,” then drive through a hall, i.e., an indoor area “Indoor,” in order to then terminate its travel again at the place of destination Z in the outdoor area “Outdoor.”

In order to localize its location, the driverless vehicle 1 can use a satellite-supported localization method via a GNSS 10 in the outdoor area “Outdoor.” It can thus determine its position within a global map of the relevant area, which is drawn as a cloud in the FIGURE. An outdoor area “Outdoor” usually has an infrastructure that changes again and again, i.e., there are few or no fixed orientation points at which sensors could orientate. In addition, the sensor system or the set of sensors installed on the vehicle 1 is generally sensitive to external influences such as dirt, etc. In addition, localization by means of GNSS 10 is significantly more reliable and accurate, in particular with a sufficiently strong signal, which is usually the case in the outdoor area “Outdoor.” For this reason, localization usually takes place in a satellite-supported manner. However, orientation points 11 can nevertheless be provided, e.g., in order to enable localization in areas not ideally covered by the satellite signal. If orientation points are fixed points such as building edges or are clearly defined and fixed structures in their shape, they can be stored in the global map and used for navigation.

In the FIGURE, the indoor area “Indoor” is the area within the rectangle and can be a hall or another facility that is usually roofed. An indoor area “Indoor” is identified by an existing infrastructure that is represented in a local map, which is either prepared beforehand or is created in a constantly updated manner by means of SLAM. The transition area 20 between the indoor area “Indoor” and the outdoor area “Outdoor” is marked by at least one, advantageously two orientation points 12, 13. Advantageously, orientation points 12, 13 are in each case arranged on one side of the transition 20, which is usually a gate or door or another passage, so that the width of the passage is also marked and defined therewith.

As soon as the travel path P of the vehicle 1 arrives in the transition area 20, indicated by the orientation points 12, between the outdoor area “Outdoor” and the indoor area “Indoor,” the orientation points 12 are captured, either by the set of sensors or the capture device or by both, and a switching of the localization method takes place from the capture device, which operates via GNSS 100, to the set of sensors, which operates by means of already described sensor systems internal to the vehicle, e.g., lidar, radar, camera, etc.

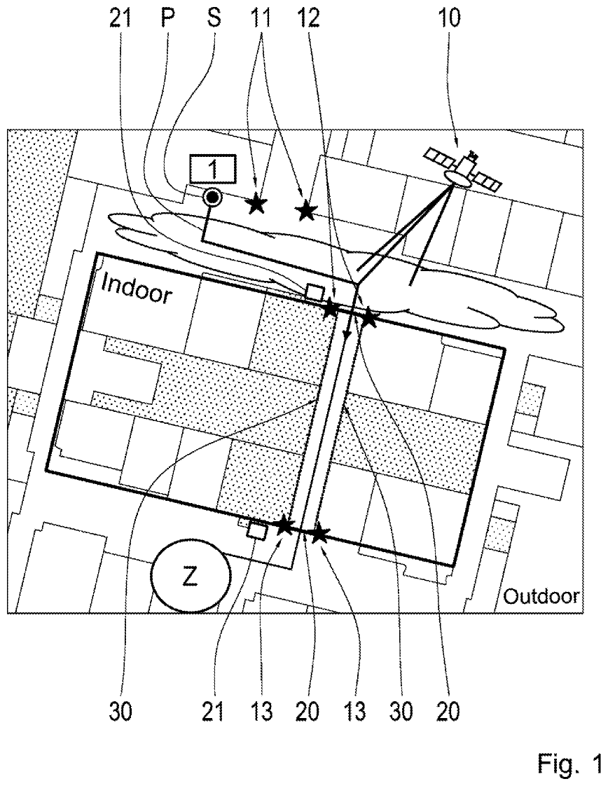

Within the indoor area “Indoor,” the driverless vehicle 1 is controlled by means of its set of sensors, e.g., by means of a combination of lidar, radar, camera, radio, WLAN, or a combination thereof, as already described. Advantageously, localization takes place by means of SLAM. In FIG. 1, the dashed line 30 marks the travel path P for the driverless vehicle 1 determined by means of laser scanning or scan matching.

As soon as the travel path P of the vehicle 1 arrives in the transition area 20, indicated by the orientation points 13, between the indoor area “Indoor” and the outdoor area “Outdoor,” the orientation points 13 are captured, and a switching of the localization method from the set of sensors to the capture device takes place so that the driverless vehicle 1 can again be localized in the outdoor area “Outdoor” by means of GNSS 10 and navigated to the place of destination Z.

In the event that a plurality of driverless vehicles 1 are present, a guidance system 21 which is arranged at the transition area 20 and can communicate with the correspondingly equipped vehicles 1 can be provided. Such guidance system 21 serves to coordinate the entrance or exit to the indoor area “Indoor” or the outdoor area “Outdoor.” In addition, it can also fulfill further tasks, e.g., coordinating the vehicles 1 and their task.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

1 Driverless vehicle
11; 12, 13 Orientation points
Transition area
Guidance system
GNSS (satellite)
Indoor Indoor area
Outdoor Outdoor area
S Starting point
Z Destination point
P Travel path

1. A localization system for a driverless vehicle configured to drive in a driverless manner from a starting point to a destination point, the localization system comprising:
a set of sensors configured to localize the vehicle indoors; and
at least one capture device configured to localize the vehicle outdoors,
wherein the localization system is configured to provide at least one orientation point at a transition area between outdoors and indoors or vice versa, and
wherein the localization is configured to switch from a localization method for localizing the vehicle indoors to a localization method for localizing the vehicle outdoors or vice versa in response to capturing, by the set of sensors and/or the capture device, the at least one orientation point.

2. The localization system according to claim 1, wherein the at least one orientation point is one of a QR code, a defined structure of an infrastructure, one or more permanently installed objects, one or more tracks, or a combination thereof.

3. The localization system according to claim 1, wherein capturing the at least one orientation point is performed by optical recording or by 3D recording.

4. The localization system according to claim 1, wherein the localization method for localizing the vehicle outdoors utilizes a global navigation satellite system (GNSS) and/or an inertial sensor system.

5. The localization system according to claim 1, wherein the set of sensors configured to localize the vehicle indoors comprises at least one of LIDAR, RADAR, camera, ultrasound, WLAN, UWB, radio, camera or a combination thereof.

6. The localization system according to claim 1, further comprising a communication device configured to communicate with a guidance system additionally provided at the transition area, wherein the guidance system is formed for the communication and control of a plurality of driverless vehicles.

7. A method for localizing a driverless vehicle with a localization system having a set of sensors configured to localize the vehicle indoors and at least one capture device configured to localize the vehicle outdoors, the method comprising:
utilizing a first localization method selected from a localization method for localizing the driverless vehicle outdoors and a localization method for localizing the driverless vehicle indoors;
detecting that the vehicle is approaching or entering a transition area between outdoors and indoors or vice versa; and
switching from the first localization method to a second localization method in response to the detecting that the vehicle is approaching or entering the transition area,
wherein the second localization method is the other of the localization method for localizing the driverless vehicle outdoors and the localization method for localizing the driverless vehicle indoors.

8. The method according to claim 7, wherein a plurality of driverless vehicles is controlled via a guidance system arranged at the transition area in such a way that coordination of the navigation of the plurality of vehicles takes place.
